(19) United States
(12) Patent Application Publication
(10) Pub. No.: US 2024/0400951 A1
(43) Pub. Date: Dec. 5, 2024

(54) COMPOSTION AND ITS USE IN CLEANING APPLICATIONS

(71) Applicant: Intelligent Fluids GmbH, Leipzig (DE)

(72) Inventors: Ronny Tepper, Leipzig (DE); Jonas Reichelt, Leipzig (DE); Alexander M. Breul, Markranstadt (DE)

(21) Appl. No.: 18/696,193

(22) PCT Filed: Sep. 29, 2022
(86) PCT No.: PCT/EP2022/077194

§ 371 Date: Mar. 27, 2024

(30) Foreign Application Priority Data
Sep. 30, 2021 (EP) 21200299.2

(51) Int. Cl. C11D 17/00; C11D 1/62; C11D 1/75; C11D 1/835; C11D 3/20; C11D 3/32; C11D 3/382; C11D 3/43

(52) U.S. Cl. CPC C11D 17/0017; C11D 1/835; C11D 3/2072; C11D 3/2093; C11D 3/2096; C11D 3/32; C11D 3/382; C11D 3/43; C11D 1/62; C11D 1/75

(57) ABSTRACT

The invention relates to a composition, comprising:
(A) water;
(B) one or more liquid olefinic unsaturated compounds having at least 8 carbon atoms in the backbone having a water solubility of less than 2 g in 1,000 g of water at 25° C., respectively;
(C) optionally one or more liquid esters having a water solubility of less than 2 g in 1,000 g of water at 25° C.;
(D) one or more amphiphilic liquid compounds;
(E) one or more of an anionic (E1), a cationic (E2), a non-ionic (E3) and optionally an amphoteric tenside (E4);
(F) optionally one or more additives.

### FIELD OF THE INVENTION

The present invention relates to a composition, preferably in the form of an emulsion, in particular in the form of a micro-emulsion, to a method of making the composition, and to a cleaning composition comprising or consisting of the composition. The present invention further relates to a method of removing deposits comprising polyolefins from internal components of a heat exchanger using the cleaning composition. The invention also relates to the use of the cleaning composition.

### BACKGROUND OF THE INVENTION

In many industrial processes, thermal energy is transferred from one material flow to another material flow, commonly using a heat exchanger. Such processes are performed e.g., in chemical plants, petrochemical plants, petroleum refineries, and natural-gas processing.

During use of the heat exchanger, it frequently cannot be avoided that material stemming from the material flows is deposited on walls of the heat exchanger. In particular, if high temperatures prevail in the heat exchanger, material may be cracked or polymerizes, thus forming deposits on internal components of the heat exchanger. These deposits typically are difficultly to remove, thus hampering the efficacy of the heat exchanger. Frequently, the heat exchanger must even be disassembled to allow cleaning the components, e.g., by a mechanical process or by liquid cleaners assisted by a mechanical process. It is evident that such a cleaning process causes additional costs which should be avoided in industrial processes.

It is particularly known that in processes in which a material flow comprising olefins such as ethylene, styrene or butadiene is passed through a heat exchanger, polyolefins are generated which are deposited on internal components of the heat exchanger.

Commercial cleaners such as hydrocarbon process aids and refinery cleaners are based on aromatic and aliphatic naphtha.

EP 2 223 995 B1 and EP 2 045 320 B1 disclose cleaning agents for removing paint layers and diverse layers of dirt from surfaces based on micro-emulsions.

### OBJECTS OF THE INVENTION

There is an ongoing need in the industry for effective cleaning agents, e.g., useful in chemical plants, petrochemical plants, petroleum refineries, and natural-gas processing. It was the object of the invention to provide a cleaning agent by means of which the interior of a heat exchanger comprising deposits comprising a polyolefin may be cleaned without the need of disassembling the heat exchanger.

### SUMMARY OF THE INVENTION

This problem could be solved by the provision of a composition as defined in the appended claims.

If the interior of a heat exchanger having polyolefin deposits thereon is subjected to the composition according to the invention, respectively a cleaning composition comprising the composition or consisting thereof, the deposits can be removed from the internal components of the heat exchanger by solubilization without the need of disassembling the heat exchanger. The resulting mixture or solution of liquid and deposits may be removed from the heat exchanger by discharging therefrom, optionally followed by rinsing. This is a considerable advantage compared to a method which requires the disassembling of the heat exchanger and subsequent cleaning of the components of the heat exchanger, e.g., by mechanical cleaning. According to a first aspect, the invention relates to a composition, preferably micro-emulsion, comprising:
(A) water;
(B) one or more liquid olefinic unsaturated compounds having a water solubility of less than 2 g in 1,000 g of water at 25° C.;
(C) optionally one or more liquid esters having a water solubility of less than 2 g in 1,000 g of water at 25° C.;
(D) one or more amphiphilic liquid compounds;
(E) one or more tensides selected from an anionic tenside (E1), a cationic tenside (E2), a non-ionic tenside (E3) and an amphoteric tenside (E4);
(F) optionally one or more additives.

Preferably, in the composition (B) comprises N,N-dimethyl 9-decenamide or methyl 9-dodecenoate; or N,N-dimethyl 9-decenamide and methyl 9-dodecenoate; or N,N-dimethyl 9-decenamide, methyl 9-dodecenoate and limonene.

Preferably, in the composition (C) comprises one or more of benzyl acetate, isopropyl myristate, and methyl salicylate.

Preferably, in the composition (D) comprises one or more of (D1), (D2), (D3) and (D4), preferably at least (D1) or (D2) or (D1) and (D2): (D1) one or more liquid ketones; (D2) one or more liquid esters; (D3) one or more liquid acetoacetates; (D4) one or more di-alcohols; preferably having a solubility of from 2 to 120 g in 1,000 g of water at 25° C.

Preferably, in the composition (D1) is selected from 2-pentanone, 3-pentanone, 3-methyl pentanone, 4-methyl-2-pentanone, 3-methyl-2-pentanone, 3,3-dimethyl-2-butanone, 2-hexanone, 3-hexanone, 2-methyl-3-pentanone, cyclopentanone and cyclohexanone, or mixtures thereof; preferably cyclopentanone; (D2) is selected from 3-methoxy-3-methyl-1-butanol esterified with C₁₋₄ carboxylic acids of formula (CH₃O)(CH₃)₂C—(CH₂)₂—OC(O)R, wherein R═H, C₁₋₄ alkyl, preferably 3-methoxy-3-methylbutylacetate; (D3) is selected from one or more acetoacetates of formula (CR₃)₃C—CO—CH₂—C(O)OR₄, wherein R₃ is independently of each other hydrogen or a C₁ to C₂ alkyl and R₄ is a branched or unbranched C₁ to C₄ alkyl, or acetoacetates of formula CH₃—CO—CH₂—C(O)—OR₅, wherein R₅ is C₁ to C₄ alkyl, or ethyl acetoacetate, isopropyl acetoacetate, methyl acetoacetate, n-butyl acetoacetate, n-propyl acetoacetate, and t-butyl acetoacetate; (D4) is selected from one or more of 2-ethyl-1,4-hexanediol, 2-methyl-2,4-pentanediol, and 2-(n-butyl)-2-ethyl-1,3-pentandiol.

Preferably, in the composition (E1), (E2), (E3), and (E4) are selected from (E1): soaps R—CH₂COONa, wherein R═C₁₁₋₁₇; alkyl benzenesulfonates R—C₆H₄—SO₃Na, wherein R=C₁₀₋₁₃; alkane sulfonates R₁R₂CH—SO₃Na, wherein R₁+R₂=C₁₂₋₁₆; α-olefin sulfonates R—CH₂—CH═CH—(CH₂)ₙ—SO₃Na, wherein R=C₁₀₋₁₄; sodium salts of sulfated fatty acids derived from vegetable oils and α-sulfo fatty acid methyl esters R—CH(SO₃Na)—COOCH₃, wherein R=C₁₄₋₁₆; alkyl sulfates R—CH₂—O—SO₃Na, wherein R=C₁₁₋₁₇; alkyl ether sulfates R₁R₂CH—O—(C₂H₄O)₂—SO₃Na, wherein R₁+R₂=C₁₀₋₁₄; alkyl ether carboxylic acids RO—(CH₂—CH₂—O)ₙ—CH₂—COOH and RO—(CH(CH₃)—CH₂—O)ₙ—CH₂—COOH, wherein R=C₄₋₂₀ and n=2-10, and two or more thereof; preferably alkyl ether carboxylic acids, sodium salts of sulfated fatty acids derived from vegetable oils; (E2): quaternary ammonium chlorides such as R₁R₂R₃R₄N⁺Cl⁻, wherein R₁, R₂=C₁₆₋₁₈; R₃, R₄=C₁, and ethoxylated C₁₂₋₁₄ alkyl(hydroxyethyl)dimethyl ammonium chloride (CAS no. 1554325-20-0), and two or more thereof; preferably quaternary C₁₂₋₁₄ alkyl methylamine ethoxylate methyl chloride; (E3): primary and secondary alcohol ethoxylates RR₁CH—O—(CH₂—CH₂—O)ₙH, wherein R=C₈₋₁₈ and R₁=H, n=3-15 for primary alcohol ethoxylates, or R+R₁=C₁₀₋₁₄ and n=3-12 for secondary alcohol ethoxylates; R—C₆H₄—O—(CH₂—CH₂—O)ₙH, wherein R=C₈₋₁₂ and n=5-10, such as C₉₋₁₁ alcohol ethoxylate (CAS no. 68439-46-3); fatty acid ethanol amides RC(O)—N(CH₂—CH₂—O)ₙH(CH₂—CH₂—O)ₙ₁H, wherein R=C₁₁₋₁₇, n=1; 2; n1=1; amine oxides C₁₂H₂₅—N(CH₃)₂O; hexyl-D-glucoside (CAS no. 54549-24-5), and two or more thereof; preferably C₉₋₁₁ alcohol ethoxylate; (E4): sulfobetaines R₁R₂R₃N⁺—(CH₂)₃—SO₃— and betaines R₁R₂R₃N⁺—CH₂—COO⁻, wherein R₁=C₁₂₋₁₈, R₂, R₃=C₁, respectively, and two or more thereof.

Preferably, the composition further comprises a base such that the pH of the emulsion is in the range of from 7.0 to 7.5.

Preferably, the composition comprises: (A) water in an amount of from 0.1 to 70 wt.-%; (B) one or more liquid olefinic unsaturated compounds having a water solubility of less than 2 g in 1,000 g of water at 25° C. in an amount of from 4 to 40 wt.-%; (C) optionally one or more liquid esters having a water solubility of less than 2 g in 1,000 g of water at 25° C. in an amount of from 0 to 40 wt.-%; (D) one or more amphiphilic liquid compounds, preferably having a water solubility of from 2 to 120 g in 1,000 g of water at 25° C., in an amount of from 2 to 30 wt.-%; (E) one or more tensides selected from an anionic tenside (E1), a cationic tenside (E2), a non-ionic tenside (E3) and an amphoteric tenside (E4) in an amount of from 15 to 60 wt.-%; (F) optionally one or more additives in an amount of from 0 to 10 wt.-%; based on the total amount of the composition (=100 wt.-%).

According to a second aspect, the invention relates to a composition, comprising: (A) water; (B) one or more liquid compounds having a water solubility of less than 2 g in 1,000 g of water at 25° C.; wherein the one or more liquid compounds are selected from alkanes, cycloalkanes, alkenes, cycloalkenes and aromatic compounds, optionally substituted; preferably wherein the alkene does not comprise N,N-dimethyl 9-decenamide or methyl 9-dodecenoate or a mixture thereof; (C) optionally one or more liquid esters having a water solubility of less than 2 g in 1,000 g of water at 25° C.; (D) one or more amphiphilic liquid compounds; wherein (D) comprises (D1) or (D2) or (D1) and (D2): (D1) is selected from the group consisting of 2-pentanone, 3-pentanone, 3-methyl pentanone, 4-methyl-2-pentanone, 3-methyl-2-pentanone, 3,3-dimethyl-2-butanone, 2-hexanone, 3-hexanone, 2-methyl-3-pentanone, cyclopentanone and cyclohexanone or mixtures thereof; preferably cyclopentanone; (D2) is selected from esterified 3-methoxy-3-methyl-1-butanol of formula (CH₃O)(CH₃)₂C—(CH₂)₂—OC(O)R, wherein R=H, C₁₋₄ alkyl, preferably 3-methoxy-3-methylbutylacetate; (E) one or more tensides selected from an anionic tenside (E1), a cationic tenside (E2), a non-ionic tenside (E3) and an amphoteric tenside (E4); (F) optionally one or more additives.

According to a second aspect, the invention relates to method of making a composition as defined in the first and second aspect, comprising: mixing compounds (A) to (E) or (A) to (F).

Preferably, the method comprises adding a base such that the pH of the composition is set to a range of from 7.0 to 7.5.

According to a fourth aspect, the invention relates to a cleaning composition, consisting of or comprising a composition as defined in the first and second aspect, or as manufactured according to the third aspect.

According to a fifth aspect, the invention relates to a method of removing deposits comprising polyolefins from internal components of a heat exchanger, comprising steps (I) to (III): (I) introducing a cleaning composition as defined in the fourth aspect of the invention into a heat exchanger; (II) allowing the cleaning composition to contact internal components of the heat exchanger which have deposits of polyolefins thereon; (III) discharging the cleaning composition and deposits suspended or dissolved therein from the heat exchanger; (IV) optionally rinsing the heat exchanger.

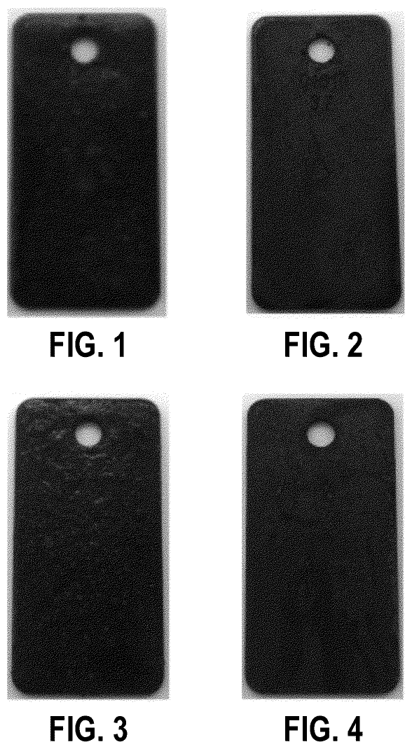

FIGS. 1 to 4 demonstrate the capability of the claimed compositions to remove deposits comprising polyolefins. Reference is made in this regard to the example section.

According to a sixth aspect, the invention relates to the use of a cleaning composition as defined in in the fourth aspect for cleaning internal components of a heat exchanger.

Preferably, the use comprises the removal of deposits comprising polyolefins from said internal components of the heat exchanger, wherein the heat exchanger is not disassembled to clean said internal components . . . .

### DETAILED DESCRIPTION OF THE INVENTION

### Composition

In a first aspect, the invention relates to a composition, comprising:
(A) water;
(B) one or more liquid olefinic unsaturated compounds having a water solubility of less than 2 g in 1,000 g of water at 25° C.;
(C) optionally one or more liquid esters having a water solubility of less than 2 g in 1,000 g of water at 25° C.;
(D) one or more amphiphilic liquid compounds;
(E) one or more tensides selected from an anionic (E1), a cationic (E2), a non-ionic tenside (E3) and an amphoteric tenside (E4); and
F) one or more additives.

The term “composition” as used herein encompasses a single-phase composition as well as an emulsion.

In one embodiment, in particular for very low contents of water, preferably less than 2% by weight based on the total amount the composition, the composition according to the invention may exist in the form of a single-phase composition.

A composition according to the invention with very low amounts of water contained therein may, in the meaning of the invention, also be termed as a “concentrate”. This concentrate may be diluted with water according to desired properties and application requirements.

In another embodiment, preferably for water contents above 2% by weight based on the total amount of the composition, the composition according to the invention may exist in the form of an emulsion.

In one embodiment, the emulsion may be a water-in-oil emulsion. In another embodiment, the emulsion may be an oil-in water-emulsion.

In a preferred embodiment, the composition according to the invention is in the form of a micro-emulsion.

The term “micro-emulsion” as used in the art and used herein encompasses a dispersion made of water, oil, and surfactant(s) that is an isotropic and thermodynamically stable system with dispersed domain diameter varying approximately from 1 to 100 nm, usually 10 to 50 nm. Thus, a “micro-emulsion” represents a fluid nanophase system. Herein, the term “oil” refers to any water-insoluble liquid.

Thus, the term “micro-emulsion” encompasses a dispersion wherein the dispersed phase is usually stabilized by surfactant and/or surfactant-cosurfactant systems.

According to the invention, the composition comprises (A) water. In one embodiment, the term “water” as used herein encompasses tap water, or partly or fully demineralized water.

According to the invention, the water-insoluble liquid (oil) (B) is represented by one or more liquid olefinic unsaturated compounds having a water solubility of less than 2 g in 1,000 g of water at 25° C., respectively.

Water solubilities as defined herein may be taken from respective textbooks or may be determined according to methods known in the art.

Preferably, the liquid olefinic unsaturated compounds have at least 8 carbon atoms in the backbone, and further preferred at least 10 carbon atoms in the backbone.

Further preferably, the solubility in water is less than 1 g in 1,000 g of water at 25° C.

The term “liquid” as used herein denotes a compound which is liquid at 25° C. Such compound may be regarded as e.g. “oil”.

The term “olefinic unsaturated compound” encompasses compounds having one or more olefinic double bonds.

In one embodiment, the liquid olefinic unsaturated compounds may consist of carbon and hydrogen only, i.e., the compounds may be alkenes such as open-chain alkenes or cyclic alkenes optionally substituted with one or more alkyl residues

Suitable alkenes are preferably selected from hexenes, octenes, nonenes, decenes, dodecenes, tetradecenes, and cyclic isomers thereof.

Further suitable alkenes are selected from terpenes such as limonene.

In another embodiment, the liquid unsaturated compounds may be substituted with functional groups. All conceivable functional groups are possible such as hydroxy groups and ester groups, provided the solubility of (B) in water is less than 2 g or less than 1 g per 1,000 g of water at 25° C.

In a preferred embodiment, (B) is or comprises N,N-dimethyl 9-decenamide (CAS no. 1356964-77-6). The compound is commercially available.

In another preferred embodiment, (B) is or comprises methyl 9-dodecenoate (CAS no. 39202-17-0). The compound is commercially available.

Due to their manufacturing process based on natural oils, both N,N-dimethyl 9-decenamide and methyl 9-dodecenoate are regarded as “green” compounds.

In another preferred embodiment, (B) is or comprises limonene. Limonene is commercially available, e.g. in form of orange oil.

In a preferred embodiment, (B) comprises N,N-dimethyl 9-decenamide or methyl 9-dodecenoate.

In another preferred embodiment, (B) comprises N,N-dimethyl 9-decenamide and methyl 9-dodecenoate.

In another preferred embodiment, (B) comprises N,N-dimethyl 9-decenamide, methyl 9-dodecenoate, and limonene.

In other preferred embodiment, (B) comprises N,N-dimethyl 9-decenamide and limonene, or methyl 9-dodecenoate and limonene.

According to the invention, the composition optionally further comprises (C) one or more liquid esters having a water solubility of less than 2 g in 1,000 g of water at 25° C. The liquid esters according to (C) are different from the compounds according to (B). The liquid esters according to (C) may also be regarded as “oil”.

Basically, all liquid esters may be used provided they have a water solubility of less than 2 g in 1,000 g of water at 25° C.

The esters may be based on aliphatic carboxylic acids such as C₁₋₆ carboxylic acids such as acetic acid or C₇₋₂₀ fatty acids or aromatic acids such as benzoic acid.

As alcohol component, preferably short chain alcohols such as methanol, ethanol or propanol are used. The use of benzyl alcohol is likewise possible.

Representative esters which are suitable in the composition according to the invention are selected from benzyl acetate, isopropyl myristate, or methyl salicylate.

In a preferred embodiment, (C) comprises a mixture of benzyl acetate, isopropyl myristate, and methyl salicylate.

The composition according to the invention contains one or more liquid, amphiphilic compounds (D), i.e., compounds which contain both hydrophilic and lipophilic functional groups. This means nothing else than that the compound is at least partly soluble both in polar solvents such as water and in non-polar solvents such as (B) and (C).

The term “amphiphilic” as used herein further means that the compound is not a tenside, i.e., the amphiphilic compound is not a compound which forms micelles at the interface between water and a water-insoluble organic compound such as (B) and (C).

Preferably, the amphiphilic compounds have a water solubility of from 2 to 120 g in 1,000 g of water at 25° C.

In a preferred embodiment, (D) comprises one or more of (D1), (D2), (D3), and (D4):
(D1) one or more ketones;
(D2) one or more esters;
(D3) one or more acetoacetates;
(D4) one or more di-alcohols.

Basically, all liquid ketones, liquid esters, liquid acetoacetates and liquid alcohols may be used as (D1) to (D4) provided they have a water solubility of from 2 to 120 g in 1,000 g of water at 25° C.

In a preferred embodiment, (D1) to (D4) have a solubility of from 5 to 50 g in 1,000 g of water at 25° C., and further preferred of from 5 to 30 g or further preferred of from 5 to 20 g in 1,000 g of water at 25° C., respectively.

Compound (D1) is a cyclic ketone such as cyclopentanone or cyclohexanone.

Compound (D1) may be selected from aliphatic ketones such as pentanones such as 2-pentanone, 3-pentanone, or 3-methyl butanone.

The use of hexanones is likewise possible. Accordingly, (D1) may also be selected from 2-hexanone, 4-methyl-2-pentanone, 3-methyl-2-pentanone, 3,3-dimethyl-2-butanone, 3-hexanone and 2-methyl-3-pentanone.

In a preferred embodiment, (D1) is cyclopentanone.

In a preferred embodiment, (D2) is 3-methoxy-3-methyl-1-butanol esterified with C₁₋₄ carboxylic acids of formula (CH₃O)(CH₃)₂C—(CH₂)₂—OC(O)R (R=H, C₁₋₄ alkyl).

3-Methoxy-3-methyl-1-butanol is commercially available (CAS no. 56539-66-3).

In a preferred embodiment, (D2) is 3-methoxy-3-methylbutylacetate. The compound is commercially available (CAS no. 103429-90-9).

In one embodiment, (D3) is selected from one or more acetoacetates of formula (CR₃)₃C—CO—CH₂—C(O)OR₄, wherein R₃ is independently of each other hydrogen or a C₁ to C₂ alkyl and R₄ is a branched or unbranched C₁ to C₄ alkyl, or acetoacetates of formula CH₃—CO—CH₂—C(O)—OR₅, wherein R₅ is C₁ to C₄ alkyl, or ethyl acetoacetate, isopropyl acetoacetate, methyl acetoacetate, n-butyl acetoacetate, n-propyl acetoacetate, or t-butyl acetoacetate.

In one embodiment, (D4) is selected from one or more of 2-ethyl-1,4-hexanediol, 2-methyl-2,4-pentanediol, or 2-(n-butyl)-2-ethyl-1,3-pentandiol.

In a preferred embodiment, the composition according to the invention contains as amphiphilic compound at least (D1) or (D2) or (D1) and (D2).

In one embodiment, the composition according to the invention may contain besides amphiphilic compounds (D1) or (D2) or (D1) and (D2) additionally one or more of (D3) and/or (D4).

In one embodiment, if desired, the composition according to the invention may also contain besides amphiphilic compounds (D1), (D2), (D3), and/or (D4) further amphiphilic compounds.

In one embodiment, the composition of the present invention does not comprise an amphiphilic compound (D3) of formula (CR₃)₃C—CO—CH₂—C(O)OR₄, wherein R₃ is independently of each other hydrogen or a C₁ to C₂ alkyl and R₄ is a branched or unbranched C₁ to C₄ alkyl, or does not comprise acetoacetates of formula CH₃—CO—CH₂—C(O)—OR₅, wherein R₅ is C₁ to C₄ alkyl, or ethyl acetoacetate, isopropyl acetoacetate, methyl acetoacetate, n-butyl acetoacetate, n-propyl acetoacetate, or t-butyl acetoacetate.

In another embodiment, the composition of the present invention does not comprise an amphiphilic compound (D4), i.e., an amphiphilic compound selected from the group consisting of 2-ethyl-1,4-hexanediol, 2-methyl-2,4-pentanediol, 2-(n-butyl)-2-ethyl-1,3-pentandiol.

According to the invention, the composition comprises (E) one or more of an anionic tenside (E1), a cationic tenside (E2), a non-ionic tenside (E3) and an amphoteric tenside (E4).

As used herein, the term “tenside” is synonymously used with the term “surfactant”. A tenside encompasses any compound which forms micelles at the interface between water and a water-insoluble organic solvent such as (B).

Suitable anionic, cationic, non-ionic, and amphoteric tensides are widely known in the art. Such tensides typically are commercially available products.

Suitable anionic tensides (E1) may be selected from:

soaps R—CH₂COONa, wherein R=C₁₁₋₁₇; alkyl benzenesulfonates R—C₆H₄—SO₃Na, wherein R=C₁₀₋₁₃; alkane sulfonates R₁R₂CH—SO₃Na, wherein R₁+R₂=C₁₂₋₁₆; α-olefin sulfonates R—CH₂—CH═CH—(CH₂)ₙ—SO₃Na, wherein R=C₁₀₋₁₄; sodium salts of sulfated fatty acids derived from vegetable oils and α-sulfo fatty acid methyl esters R—CH(SO₃Na)—COOCH₃, wherein R=C₁₄₋₁₆; alkyl sulfates R—CH₂—O—SO₃Na, wherein R=C₁₁₋₁₇; alkyl ether sulfates R₁R₂CH—O—(C₂H₄O)₂—SO₃Na, wherein R₁+R₂=C₁₀₋₁₄; alkyl ether carboxylic acids RO—(CH₂—CH₂—O)ₙ—CH₂—COOH and RO—(CH(CH₃)—CH₂—O)ₙ—CH₂—COOH, wherein R=C₄₋₂₀ and n=2-10, and two or more thereof.

Suitable cationic tensides (E2) may be selected from:

quaternary ammonium chlorides such as R₁R₂R₃R₄N⁺Cl⁻, wherein R₁, R₂=C₁₆₋₁₈; R₃, R₄=C₁, and ethoxylated C₁₂₋₁₄ alkyl(hydroxyethyl)dimethyl ammonium chloride (CAS no. 1554325-20-0), and two or more thereof.

Suitable non-ionic tensides (E3) may be selected from:

primary and secondary alcohol ethoxylates RR₁CH—O—(CH₂—CH₂—O)ₙH, wherein R=C₈₋₁₈ and R₁=H, n=3-15 for primary alcohol ethoxylates, or R+R₁=C₁₀₋₁₄ and n=3-12 for secondary alcohol ethoxylates; R—C₆H₄—O—(CH₂—CH₂—O)ₙH, wherein R=C₈₋₁₂ and n=5-10, such as C₉₋₁₁ alcohol ethoxylate (CAS no. 68439-46-3); fatty acid ethanol amides RC(O)—N(CH₂—CH₂—O)ₙH(CH₂—CH₂—O)ₙ₁H, wherein R=C₁₁₋₁₇, n=1; 2; n1=1; amine oxides C₁₂H₂₅—N(CH₃)₂O; hexyl-D-glucoside (CAS no. 54549-24-5), and two or more thereof

Suitable amphoteric tensides (E4) may be selected from:

sulfobetaines R₁R₂R₃N⁺—(CH₂)₃—SO₃⁻ and betaines R₁R₂R₃N⁺—CH₂—COO⁻, wherein R₁=C₁₂₋₁₈, R₂, R₃=C₁, respectively, and two or more thereof.

The tensides as defined above may contain water as is known in the art.

Particularly preferred anionic tensides are selected from alkyl ether carboxylic acids, sodium salts of sulfated fatty acids derived from vegetable oils, and α-sulfo fatty acid methyl esters or two or more thereof.

Particularly preferred cationic tensides are selected from ethoxylated C₁₂₋₁₄ alkyl(hydroxyethyl)dimethyl ammonium chloride.

Particularly preferred non-ionic tensides are selected from C₉₋₁₁ alcohol ethoxylates and hexyl-D-glucoside or two or more thereof.

In a preferred embodiment, the composition according to the invention comprises a mixture of tensides (E1), (E2), (E3) and optionally (E4).

The composition according to the invention may contain (F) one or more additives.

In a preferred embodiment, the additive is a corrosion inhibitor. A suitable corrosion inhibitor preferably is benzotriazole.

The composition may also contain a fragrance, if desired.

In a preferred embodiment, the composition according to the invention comprises:
(A) water in an amount of from 0.1 to 70 wt.-%;
(B) one or more liquid olefinic unsaturated compounds having a water solubility of less than 2 g in 1,000 g of water at 25° C., in an amount of from 4 to 40 wt.-%;
(C) optionally one or more liquid esters having a water solubility of less than 2 g in 1,000 g of water at 25° C., respectively, in an amount of from 0 to 40 wt.-%;
(D) one or more amphiphilic liquid compounds in an amount of from 2 to 30 wt.-%;
(E) one or more tensides selected from an anionic tenside (E1), a cationic tenside (E2), a non-ionic tenside (E3) and optionally an amphoteric tenside (E4) in an amount of from 15 to 60 wt.-%;
(F) optionally one or more additives in an amount of from 0 to 10 wt.-%;
based on the total amount of the composition (=100 wt.-%), respectively.

In another embodiment, the composition comprises:
(A) water in an amount of from 2 to 60 wt.-%;
(B) one or more liquid olefinic unsaturated compounds having a water solubility of less than 2 g in 1,000 g of water at 25° C., respectively, in an amount of from 5 to 30 wt.-%;
(C) optionally one or more liquid esters having a water solubility of less than 2 g in 1,000 g of water at 25° C., respectively, in an amount of from 5 to 40 wt.-%, or preferably 5 to 30 wt %
(D) one or more amphiphilic liquid compounds having a water solubility of from 2 to 120 g in 1,000 g of water at 25° C., respectively, in an amount of from 2 to 25 wt.-%;
(E) one or more of a tensides selected from an anionic tenside (E1), a cationic tenside (E2), a non-ionic tenside (E3) and optionally an amphoteric tenside (E4) in an amount of from 20 to 55 wt.-%;
(F) one or more additives in an amount of from 0 to 10 wt.-%; based on the total amount of the composition (=100 wt.-%), respectively.

In still another embodiment, the composition comprises:
(A) water in an amount of from 10 to 50 wt.-%;
(B) one or more liquid olefinic unsaturated compounds having a water solubility of less than 2 g in 1,000 g of water at 25° C. in an amount of from 5 to 25 wt.-%;
(C) optionally one or more liquid esters having a water solubility of less than 2 g in 1,000 g of water at 25° C., respectively, in an amount of from 5 to 25 wt.-%;
(D) one or more amphiphilic liquid compounds having a water solubility of from 2 to 120 g in 1,000 g of water at 25° C., respectively, in an amount of from 5 to 25 wt.-%;
(E) one or more of a tenside selected from an anionic tenside (E1), a cationic tenside (E2), a non-ionic tenside (E3) and optionally an amphoteric tenside (E4) in an amount of from 25 to 40 wt.-%;
(F) one or more additives in an amount of from 0 to 10 wt.-%;
based on the total amount of the composition (=100 wt.-%), respectively.

Preferably, the composition additionally contains a base such as sodium hydroxide in order to provide a pH of from 7 to 8.0, preferably 7 to 7.5.

However, the pH of the composition may also be set to an acidic range.

In a second aspect, the invention relates to another composition, comprising:
(A) water;
(B) one or more liquid compounds having a water solubility of less than 2 g in 1,000 g of water at 25° C.;
(C) optionally one or more liquid esters having a water solubility of less than 2 g in 1,000 g of water at 25° C.;
(D) one or more amphiphilic liquid compounds; wherein (D) comprises (D1) and (D2) or (D1) and (D2) and optionally (D3) and/or (D4);
(E) one or more tensides selected from an anionic tenside (E1), a cationic tenside (E2), a non-ionic tenside (E3) and an amphoteric tenside (E4);
(F) one or more additives.

Compound (A) is as defined in the first aspect.

In one embodiment, (B) is selected from alkanes, cycloalkanes, and aromatic compounds, optionally substituted.

Preferred alkanes and cycloalkanes are based on C₆ to C₁₅ alkanes and cycloalkanes.

Preferred aromatic compounds are based on benzene such as benzene as such, toluene, or xylene.

In another preferred embodiment, (B) is selected from C₆ to C₁₅ alkenes and cycloalkenes. In one embodiment, the alkene or cycloalkene does not comprise N,N-dimethyl 9-decenamide nor methyl 9-dodecenoate.

Compounds (C), (D), (E) and (F) refer to the same compounds as defined in the first aspect.

Thus, (D1) is selected from 2-pentanone, 3-pentanone, 3-methyl pentanone, 4-methyl-2-pentanone, 3-methyl-2-pentanone, 3,3-dimethyl-2-butanone, 2-hexanone, 3-hexanone, 2-methyl-3-pentanone, cyclopentanone and cyclohexanone, preferably cyclopentanone.

(D2) is selected from 3-methoxy-3-methyl-1-butanol esterified with C₁₋₄ carboxylic acids of formula (CH₃O)(CH₃)₂C—(CH₂)₂—OC(O)R, wherein R=H, C₁₋₄ alkyl, preferably 3-methoxy-3-methylbutylacetate.

In a preferred embodiment, (E) comprises a mixture of (E1), (E2), (E3) and optionally (E4).

Accordingly, in one embodiment of the second aspect, the invention relates to a composition, comprising:
(A) water;
(B) one or more liquid compounds having a water solubility of less than 2 g in 1,000 g of water at 25° C., respectively; wherein the one or more liquid compounds are selected from alkanes, cycloalkanes, alkenes, cycloalkenes and aromatic compounds, optionally substituted, respectively; wherein the alkene does not comprise N,N-dimethyl 9-decenamide or methyl 9-dodecenoate or a mixture thereof;
(C) optionally one or more liquid esters having a water solubility of less than 2 g in 1,000 g of water at 25° C., respectively;
(D) one or more amphiphilic liquid compounds; wherein (D) comprises (D1) or (D2) or (D1) and (D2):
   (D1) is selected from 2-pentanone, 3-pentanone, 3-methyl pentanone, 4-methyl-2-pentanone, 3-methyl-2-pentanone, 3,3-dimethyl-2-butanone, 2-hexanone, 3-hexanone, 2-methyl-3-pentanone, cyclopentanone and cyclohexanone, preferably cyclopentanone;
   (D2) is selected from esterified 3-methoxy-3-methyl-1-butanol of formula (CH₃O)(CH₃)₂C—(CH₂)₂—OC(O)R, wherein R=H, C₁₋₄ alkyl, preferably 3-methoxy-3-methylbutylacetate;
(E) one or more tensides selected from an anionic tenside (E1), a cationic tenside (E2), a non-ionic tenside (E3) and an amphoteric tenside (E4);
(F) one or more additives.

In one embodiment, the composition comprises:
(A) water in an amount of from 0.1 to 70 wt.-%;
(B) one or more liquid compounds having a water solubility of less than 2 g in 1,000 g of water at 25° C., respectively; in an amount of from 4 to 40 wt.-%;
(C) optionally one or more liquid esters having a water solubility of less than 2 g in 1,000 g of water at 25° C., respectively, in an amount of from 0 to 40 wt.-%, or 5 to 40 wt %;
(D) one or more amphiphilic liquid compounds in an amount of from 2 to 20 wt.-%; wherein (D) comprises (D1) or (D2) or (D1) and (D2):
   (D1) is selected from 2-pentanone, 3-pentanone, 3-methyl pentanone, 4-methyl-2-pentanone, 3-methyl-2-pentanone, 3,3-dimethyl-2-butanone, 2-hexanone, 3-hexanone, 2-methyl-3-pentanone, cyclopentanone and cyclohexanone, preferably cyclopentanone;
   (D2) is selected from esterified 3-methoxy-3-methyl-1-butanol of formula (CH₃O)(CH₃)₂C—(CH₂)₂—OC(O)R, wherein R=H, C₁₋₄ alkyl, preferably 3-methoxy-3-methylbutylacetate.
(E) one or more tensides of an anionic tenside (E1), a cationic tenside (E2), a non-ionic tenside (E3) and an amphoteric tenside (E4) in an amount of from 15 to 60 wt.-%;
(F) one or more additives in an amount of from 0 to 10 wt.-%;
based on the total amount of the composition (=100 wt.-%).

### Method of Making the Composition

In a further aspect, the invention relates to a method of making the compositions according to the invention.

The method comprises the step of mixing compounds (A) to (E), respectively (A) to (F) as defined in the other aspects of the invention.

In one embodiment, the method comprises the addition of a base such that the pH of the composition is set to a range of from 7.0 to 8, preferably 7.0 to 7.5. A suitable base is e.g., sodium hydroxide.

In the process of mixing, a micro-emulsion may be spontaneously formed without the need of using particular mixing devices such as highspeed homogenizers.

### Cleaning Composition

In still another aspect, the invention relates to a cleaning composition.

In one embodiment, the cleaning composition comprises the composition according to the invention or the composition manufactured according to the method according to the invention as defined in the other aspects of the invention.

In another embodiment, the cleaning composition consists of the composition according to the invention as defined in the other aspects of the invention. Preferably the composition is a micro emulsion.

Method of Removing Deposits Comprising Polyolefins from Internal Components of a Heat Exchanger

In still another aspect, the invention relates to a method of removing deposits comprising polyolefins from internal components of a heat exchanger.

The method comprises the following steps (I) to (III):
(I) introducing the cleaning composition according to the invention as defined in the other aspect of the invention into a heat exchanger;
(II) allowing the cleaning composition to contact internal components of the heat exchanger which have deposits of polyolefins thereon;
(Ill) discharging the cleaning composition and deposits suspended or dissolved therein from the heat exchanger;
(V) optionally rinsing the heat exchanger.

The term “allowing the cleaning composition to contact internal components of the heat exchanger which have deposits of polyolefins thereon” as used in step (II) means that the cleaning composition has a certain residence time in the heat exchanger, i.e., a time sufficient to remove the deposits.

The time sufficient to remove the deposits depends inter alia on the thickness of the deposits. Typically, the range is from 5 minutes to 5 days, preferably from 30 min to 10 hours.

### Use of the Cleaning Composition According to the Invention

According to a further aspect, the invention relates to the use of the cleaning composition according to the invention as defined in the other aspect of the invention.

In one embodiment, the cleaning composition is used for cleaning internal components of a heat exchanger.

According to the invention, the cleaning comprises the removal of deposits comprising polyolefins from said internal components of the heat exchanger.

Further according to the invention, the heat exchanger is not disassembled to clean said internal components.

### EXAMPLES

### Example 1: Preparation of a Composition A

337 g quaternary ethoxylated C₉₋₁₁ coco alkylbis(hydroxyethyl)methyl ammonium chloride (CAS-Nb. 61791-10-4; 20 to 40%) was filled into a beaker. While stirring, 86.3 g lauramine oxide (30%) was added, Subsequently, while continuously stirring, 19.2 g orange oil, 46.0 g N,N-dimethyl-9-deceanamide, 19.2 g methyl-9-dodecenoate, 46.0 g isopropyl myristate, 46.0 g ethyl salicylate, 46.0 g benzyl acetate, 19.2 g cyclopentanone, 46.0 g 1-butanol-3-methoxy-3-methyl acetate, 19.2 g Solverde GS 2050 (mixture of sojamethyl ester (CAS Nb. 67784-80-9) and succinic acid dimethyl ester (CAS-Nb. 106-65-0)), 76.7 g iso-propyliden glycerine and 193.2 g water were added. After stirring for a period of at least ten minutes, a micro-solution was formed.

### Example 2: Application Example A1

Two representative deposits were taken from heat exchangers, namely polystyrene and a mixture of polystyrene and polybutadiene.

0.5 g deposit was respectively covered with 10 mL of the micro-emulsion of Example 1. Solubilization of the deposits was evaluated after 1.5 h, 5 h, 24 h and 5 days.

The samples showed significant solubilization after 5 h and complete solubilization after 5 days.

### Example 3: Application Example A2

One coupon covered with deposits from heat exchangers was weighed and put into a 100 ml beaker. The baker was then equipped with a magnetic stirrer and filled with 100 ml of composition A (according to Example 1). The magnetic stirrer was set to a stirring speed of 500 rpm. After 60 minutes of cleaning, the coupon was removed from the beaker, flushed with water and then let dried (i.e. drying under ambient conditions). The thus cleaned and dried coupon was again weighed.

FIG. 1 depicts the coupon prior to cleaning and FIG. 2 depicts the coupon after cleaning. The weight of the coupon covered with deposit prior to cleaning was 16.53 g. The weight after the cleaning was 16.40 g. The weight of the coupon without the deposit and prior to cleaning was 16.37 g. Thus, it is proven that the cleansing composition A effectively removes the deposit.

### Example 4: Preparation of a Composition B

361.5 g quaternary ethoxylated C₉₋₁₁ coco alkylbis(hydroxyethyl)methyl ammonium chloride (CAS-Nb. 61791-10-4; 20 to 40%) was filled into a beaker. While stirring, 92.5 g lauramine oxide (30%) was added. Subsequently, while continuously stirring, 20.0 g orange oil, 49.5 g isopropyl myristate, 49.5 g ethyl salicylate, 49.5 g benzyl acetate, 20.0 g cyclopentanone, 49.5 g 1-butanol-3-methoxy-3-methyl acetate, 20.0 g Solverde GS 2050 (mixture of sojamethyl ester (CAS Nb. 67784-80-9) and succinic acid dimethyl ester (CAS-Nb. 106-65-0)), 82.0 g iso-propyliden glycerine and 206.0 g water were added. After stirring for a period of at least ten minutes, a micro-solution was formed.

### Example 5: Application Example B

The Application Example A2 was repeated with the only difference that cleaning composition B (according to Example 4) was used instead of composition A.

FIG. 3 depicts the coupon prior to cleaning and FIG. 4 depicts the coupon after cleaning. The weight of the coupon prior to cleaning but covered with deposit was 16.62 g. The weight after the cleaning was 16.36 g. The weight of the coupon without the deposit and prior to cleaning was 16.34 g. Thus, it is proven that the cleansing composition B effectively removes the deposit.

### Example 6 (Comparative)

0.5 g deposit was respectively covered with 10 mL of a commercial refinery cleaner based on aromatic naphtha. The observed interaction was negligible even after 5 days.

1. Composition, comprising:
(A) water;
(B) one or more liquid olefinic unsaturated compounds having a water solubility of less than 2 g in 1,000 g of water at 25° C.;
(C) optionally one or more liquid esters having a water solubility of less than 2 g in 1,000 g of water at 25° C.;
(D) one or more amphiphilic liquid compounds;
(E) one or more tensides selected from an anionic tenside (E1), a cationic tenside (E2), a non-ionic tenside (E3), and an amphoteric tenside (E4); and
(F) optionally one or more additives.

2. Composition of claim 1, wherein
(B) comprises N,N-dimethyl 9-decenamide or methyl 9-dodecenoate; or
N,N-dimethyl 9-decenamide and methyl 9-dodecenoate; or
N,N-dimethyl 9-decenamide, methyl 9-dodecenoate and limonene.

3. Composition of claim 1, wherein
(C) comprises one or more of benzyl acetate, isopropyl myristate, and methyl salicylate.

4. Composition of claim 1, wherein (D) comprises one or more of (D1), (D2), (D3) and (D4):
(D1) one or more liquid ketones;
(D2) one or more liquid esters;
(D3) one or more liquid acetoacetates;
(D4) one or more di-alcohols.

5. Composition of claim 4, wherein
(D1) is selected from 2-pentanone, 3-pentanone, 3-methyl pentanone, 4-methyl-2-pentanone, 3-methyl-2-pentanone, 3,3-dimethyl-2-butanone, 2-hexanone, 3-hexanone, 2-methyl-3-pentanone, cyclopentanone and cyclohexanone, or mixtures thereof;
(D2) is selected from 3-methoxy-3-methyl-1-butanol esterified with C₁₋₄ carboxylic acids of formula (CH₃O)(CH₃)₂C—(CH₂)₂—OC(O)R, wherein R=H, C₁₋₄ alkyl;
(D3) is selected from one or more acetoacetates of formula (CR₃)₃C—CO—CH₂—C(O)OR₄, wherein R₃ is independently of each other hydrogen or a C₁ to C₂ alkyl and R₄ is a branched or unbranched C₁ to C₄ alkyl, or acetoacetates of formula CH₃—CO—CH₂—C(O)—OR₅, wherein R₅ is C₁ to C₄ alkyl, or ethyl acetoacetate, isopropyl acetoacetate, methyl acetoacetate, n-butyl acetoacetate, n-propyl acetoacetate, and t-butyl acetoacetate;
(D4) is selected from one or more of 2-ethyl-1,4-hexanediol, 2-methyl-2,4-pentanediol, and 2-(n-butyl)-2-ethyl-1,3-pentandiol.

6. Composition of claim 1, wherein (E1), (E2), (E3), and (E4) are selected from
(E1): soaps R—CH₂COONa, wherein R=C₁₁₋₁₇; alkyl benzenesulfonates R—C₆H₄—SO₃Na, wherein R=C₁₀₋₁₃; alkane sulfonates R₁R₂CH—SO₃Na, wherein R₁+R₂=C₁₂₋₁₆; α-olefin sulfonates R—CH₂—CH═CH—(CH₂)ₙ—SO₃Na, wherein R=C₁₀₋₁₄; sodium salts of sulfated fatty acids derived from vegetable oils and α-sulfo fatty acid methyl esters R—CH(SO₃Na)—COOCH₃, wherein R=C₁₄₋₁₆; alkyl sulfates R—CH₂—O—SO₃Na, wherein R=C₁₁₋₁₇; alkyl ether sulfates R₁R₂CH—O—(C₂H₄O)₂—SO₃Na, wherein R₁+R₂=C₁₀₋₁₄; alkyl ether carboxylic acids RO—(CH₂—CH₂—O)ₙ—CH₂—COOH and RO—(CH(CH₃)—CH₂—O)ₙ—CH₂—COOH, wherein R=C₄₋₂₀ and n=2-10, and two or more thereof;
(E2): quaternary ammonium chlorides such as R₁R₂R₃R₄N⁺Cl⁻, wherein R₁, R₂=C₁₆₋₁₈; R₃, R₄=C₁, and ethoxylated C₁₂₋₁₄ alkyl(hydroxyethyl)dimethyl ammonium chloride (CAS no. 1554325-20-0), and two or more thereof;
(E3): primary and secondary alcohol ethoxylates RR₁CH—O—(CH₂—CH₂—O)ₙH, wherein R=C₈₋₁₈ and R₁=H, n=3-15 for primary alcohol ethoxylates, or R+R₁=C₁₀₋₁₄ and n=3-12 for secondary alcohol ethoxylates; R—C₆H₄—O—(CH₂—CH₂—O)ₙH, wherein R=C₈₋₁₂ and n=5-10, such as C₉₋₁₁ alcohol ethoxylate (CAS no. 68439-46-3); fatty acid ethanol amides RC(O)—N(CH₂—CH₂—O)ₙH(CH₂—CH₂—O)ₙ₁H, wherein R=C₁₋₇, n=1; 2; n1=1; amine oxides C₁₂H₂₅—N(CH₃)₂O; hexyl-D-glucoside (CAS no. 54549-24-5), and two or more thereof;
(E4): sulfobetaines R₁R₂R₃N⁺—(CH₂)₃—SO₃⁻ and betaines R₁R₂R₃N⁺—CH₂—COO⁻, wherein R₁=C₁₂₋₁₈, R₂, R₃=C₁, respectively, and two or more thereof.

7. Composition of claim 1, further comprising a base such that the pH of the emulsion is in the range of from 7.0 to 7.5.

8. Composition of claim 1, comprising:
(A) water in an amount of from 0.1 to 70 wt.-%;
(B) one or more liquid olefinic unsaturated compounds having a water solubility of less than 2 g in 1,000 g of water at 25° C. in an amount of from 4 to 40 wt.-%;
(C) optionally one or more liquid esters having a water solubility of less than 2 g in 1,000 g of water at 25° C. in an amount of from 0 to 40 wt.-%;
(D) one or more amphiphilic liquid compounds in an amount of from 2 to 30 wt.-%;
(E) one or more tensides selected from an anionic tenside (E1), a cationic tenside (E2), a non-ionic tenside (E3) and an amphoteric tenside (E4) in an amount of from 15 to 60 wt.-%; and
(F) optionally one or more additives in an amount of from 0 to 10 wt.-%;
based on the total amount of the composition (=100 wt.-%).

9. Composition, comprising:
(A) water;
(B) one or more liquid compounds having a water solubility of less than 2 g in 1,000 g of water at 25° C.; wherein the one or more liquid compounds are selected from alkanes, cycloalkanes, alkenes, cycloalkenes and aromatic compounds, optionally substituted;
(C) optionally one or more liquid esters having a water solubility of less than 2 g in 1,000 g of water at 25° C.;
(D) one or more amphiphilic liquid compounds; wherein (D) comprises (D1) or (D2) or (D1) and (D2):
(D1) is selected from the group consisting of 2-pentanone, 3-pentanone, 3-methyl pentanone, 4-methyl-2-pentanone, 3-methyl-2-pentanone, 3,3-dimethyl-2-butanone, 2-hexanone, 3-hexanone, 2-methyl-3-pentanone, cyclopentanone and cyclohexanone or mixtures thereof;
(D2) is selected from esterified 3-methoxy-3-methyl-1-butanol of formula (CH₃O)(CH₃)₂C—(CH₂)₂—OC(O)R, wherein R=H, C₄ alkyl;
(E) one or more tensides selected from an anionic tenside (E1), a cationic tenside (E2), a non-ionic tenside (E3) and an amphoteric tenside (E4); and
(F) optionally one or more additives.

10. Method of making a composition as defined in claim 1, comprising: mixing compounds (A) to (E) or (A) to (F).

11. Method of claim 10, comprising: adding a base such that the pH of the composition is set to a range of from 7.0 to 7.5.

12. Cleaning composition comprising a composition as defined in claim 1.

13. Method of removing deposits comprising polyolefins from internal components of a heat exchanger, comprising steps (I) to (III):
(I) introducing a cleaning composition comprising a composition as defined in claim 1 into a heat exchanger;
(II) allowing the cleaning composition to contact internal components of the heat exchanger which have deposits of polyolefins thereon;
(III) discharging the cleaning composition and deposits suspended or dissolved therein from the heat exchanger; and
(IV) optionally rinsing the heat exchanger.

14. Use of a cleaning composition comprising a composition as defined in claim 1 for cleaning internal components of a heat exchanger.

15. Use of claim 14, wherein the cleaning comprises the removal of deposits comprising polyolefins from said internal components of the heat exchanger, wherein the heat exchanger is not disassembled to clean said internal components.

16. Composition of claim 4, wherein (D) comprises at least (D1) or (D2) or (D1) and (D2):
(D1) is cyclopentanone;
(D2) is 3-methoxy-3-methylbutylacetate.

17. Composition of claim 9, wherein
(D1) is cyclopentanone;
(D2) is 3-methoxy-3-methylbutylacetate.

18. Composition, comprising:
(A) water;
(B) one or more liquid olefinic unsaturated compounds having a water solubility of less than 2 g in 1,000 g of water at 25° C.;
(C) one or more liquid esters having a water solubility of less than 2 g in 1,000 g of water at 25° C.;
(D) one or more amphiphilic liquid compounds;
(E) one or more tensides selected from an anionic tenside (E1), a cationic tenside (E2), a non-ionic tenside (E3), and an amphoteric tenside (E4); and
(F) optionally one or more additives.

19. Composition of claim 16, comprising:
(A) water in an amount of from 0.1 to 70 wt.-%;
(B) one or more liquid olefinic unsaturated compounds having a water solubility of less than 2 g in 1,000 g of water at 25° C. in an amount of from 4 to 40 wt.-%;
(C) one or more liquid esters having a water solubility of less than 2 g in 1,000 g of water at 25° C. in an amount of from 0 to 40 wt.-%;
(D) one or more amphiphilic liquid compounds having a water solubility of from 2 to 120 g in 1,000 g of water at 25° C. in an amount of from 2 to 30 wt.-%;
(E) one or more tensides selected from an anionic tenside (E1), a cationic tenside (E2), a non-ionic tenside (E3), and an amphoteric tenside (E4) in an amount of from 15 to 60 wt.-%; and
(F) one or more additives in an amount of from 0 to 10 wt.-%;
based on the total amount of the composition (=100 wt.-%).
